(19) United States
(12) Patent Application Publication
(10) Pub. No.: US 2020/0206891 A1
(43) Pub. Date: Jul. 2, 2020

(54) TOOL STORAGE DEVICE

(71) Applicant: MING-HUNG LIN, Taichung City (TW)

(72) Inventor: MING-HUNG LIN, Taichung City (TW)

(21) Appl. No.: 16/291,543

(22) Filed: Mar. 4, 2019

(30) Foreign Application Priority Data
Dec. 27, 2018 (TW) 107217754

(51) Int. Cl. B25H 3/00; B25H 3/04

(52) U.S. Cl. CPC B25H 3/003; B25H 3/04

(57) ABSTRACT

A tool storage device is provided, including a base and a seat. The base includes a receiving portion, and the receiving portion includes an accommodation room and a wall defining the accommodation room. The seat is swingably disposed within the accommodation room, and the seat includes a slot and at least one elastic aim. The slot is configured to detachably receive a workpiece, and the at least one elastic arm is disengageably abutted laterally against the wall and configured to urge the workpiece within the slot.

### BACKGROUND OF THE INVENTION

### Field of the Invention

The present invention relates to a tool storage device.

### Description of the Prior Art

Generally, tool bits with various shapes and sizes are required to assemble or disassemble different types of screws (such as phillips, slotted and pozidriv). The tool bits are usually stored in a toolbox for being portable.

A toolbox with movable bit storage holders is disclosed in Taiwan Patent No. 1595984, including a casing, a pair of rails and at least one bit storage holder. The casing has a receptacle, and the rails are mounted on two opposite walls of the receptacle of the casing. The at least one bit storage holder is slidably disposed on the pair of rails and rotatable relative to the casing. The at least one bit storage holder has at least one hole for insertion of a workpiece (such as tool bit). However, a conventional toolbox is configured to receive the workpiece within the at least one hole and does not have any structure for positioning the workpiece so that the workpiece is easy to be disengaged out from the at least one hole when the at least one bit storage holder is pivoted relative to the casing.

The present invention is, therefore, arisen to obviate or at least mitigate the above-mentioned disadvantages.

### SUMMARY OF THE INVENTION

The main object of the present invention is to provide a tool storage device which has a simple structure capable of releasably restricting a workpiece.

To achieve the above and other objects, the present invention provides a tool storage device, including a base and a seat. The base includes a receiving portion, and the receiving portion includes an accommodation room and a wall defining the accommodation room. The seat is swingably disposed within the accommodation room, and the seat includes a slot and at least one elastic arm. The slot is configured to detachably receive a workpiece, and the at least one elastic arm is disengageably abutted laterally against the wall and configured to urge the workpiece within the slot.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferable embodiment of the present invention;

FIG. 2 is a stereogram of a seat of the first preferable embodiment of the present invention;

FIG. 3 is a breakdown drawing of the first preferable embodiment of the present invention;

FIG. 4 is a cross-sectional view of the first preferable embodiment of the present invention;

FIG. 5 is a partial enlargement of FIG. 4;

FIG. 6 is a schematic diagram of the first preferable embodiment of the present invention in use;

FIG. 7 is a cross-sectional view of a second preferable embodiment of the present invention;

FIG. 8 is a partial enlargement of FIG. 7;

FIG. 9 is another stereogram of the first preferable embodiment of the present invention.

### DETAILED DESCRIPTION OF THE PREFERRED EMBODIMENTS

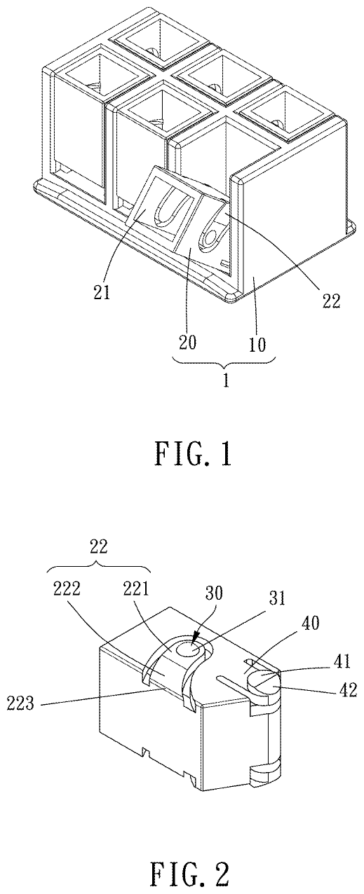

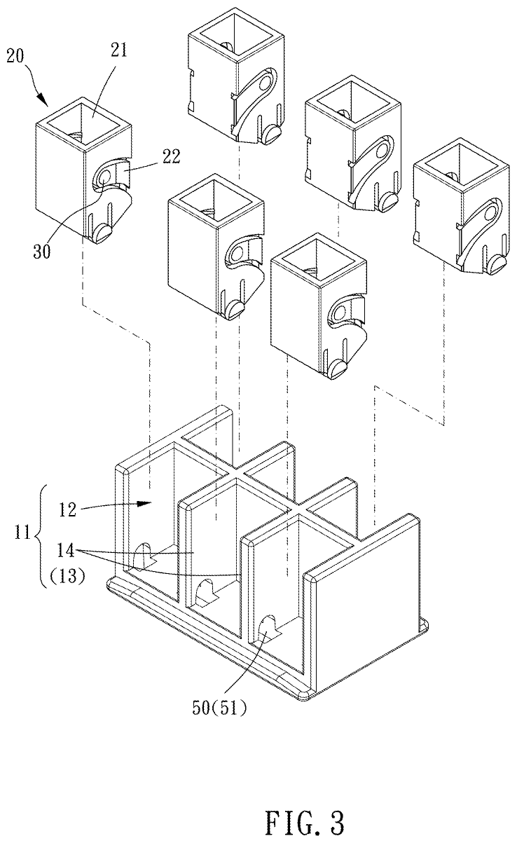

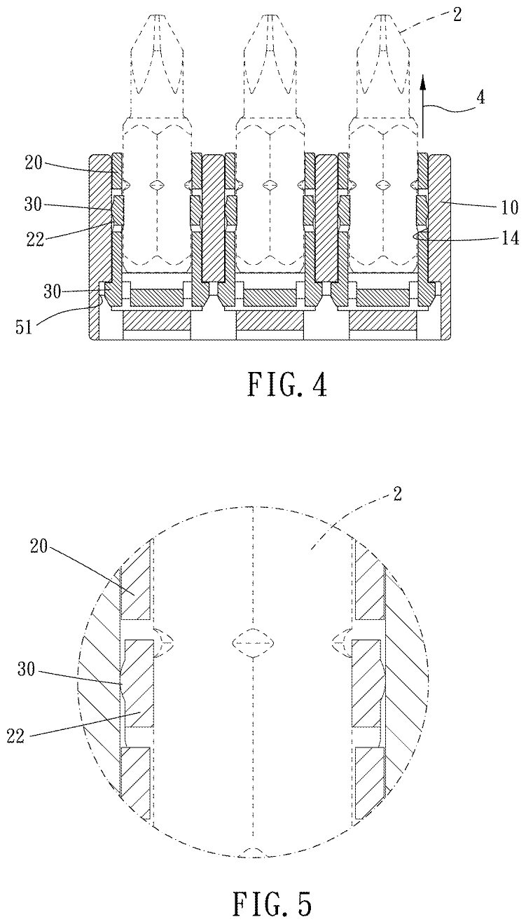

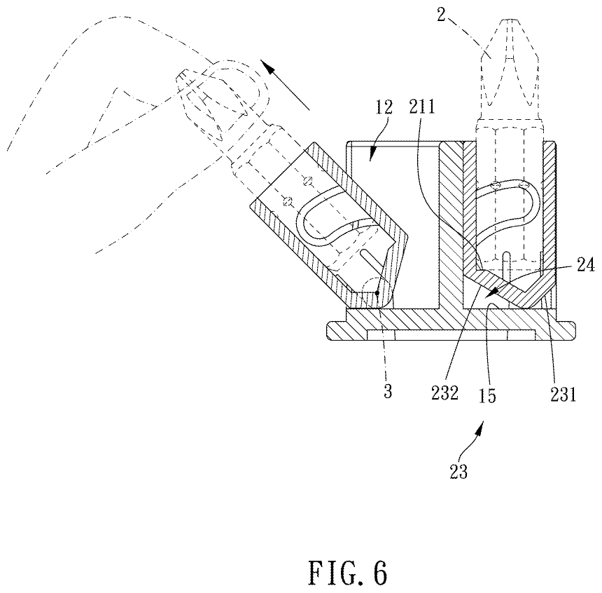

Please refer to FIGS. 1 to 6 for a first preferable embodiment of the present invention. A tool storage device 1 of the present invention includes a base 10 and a seat 20.

The base 10 includes a receiving portion 11, and the receiving portion 11 includes an accommodation room 12 and a wall 13 defining the accommodation room 12. The seat 20 is swingably disposed within the accommodation room 12, and the seat 20 includes a slot 21 and at least one elastic arm 22. The slot 21 is configured to detachably receive a workpiece 2 (such as a tool bit), and the at least one elastic arm 22 is disengageably abutted laterally against the wall 13 and configured to urge the workpiece 2 within the slot 21. Therefore, it has a simple structure, and the seat 20 can releasably restrict the workpiece 2 therewithin In this embodiment, the at least one elastic arm 22 is disengaged from the wall 13 and the workpiece 2 is easily removable from the slot 21 when the seat 20 is swung out of the accommodation room 12; the at least one elastic arm 22 is abutted against the wall 13 and configured to urge the workpiece 2 within the slot 21 when the seat 20 is swung within the accommodation room 12.

In this embodiment, a number of the receiving portion 11 is plural, and a number of the seat 20 corresponds to the number of the receiving portion 11 so as to receive a plurality of workpieces 2.

The wall 13 extends circumferentially. Specifically, the seat 20 swings relative to the accommodation room 12 about a rotation axis 3, and the wall 13 includes two side walls 14 oppositely arranged. The rotation axis 3 extends through the two side walls 14, and the at least one elastic arm 22 is disengageably abutted against one of the two side walls 14 and configured to stably restrict the workpiece 2.

The seat 20 includes two of said elastic arms 22, and the two of said elastic arms 22 are disengageably abutted against respective one of the two side walls 14. In other embodiments, each of the two of said elastic arms may be abutted against respective one of two adjacent side walls; a number of the at least one elastic arm may be larger than two. Preferably, the slot 21 is open toward a first direction 4, and the two of said elastic arms 22 extend transvers to the first direction 4 so as to increase restriction of the workpiece 2 and achieve preferable restriction effect, and the seat 20 is smoothly swingable relative to the accommodation room 12. Specifically, each of the two of said elastic arms 22 includes an abutting section 221 and a curve section 222 which is connected between the seat 20 and the abutting section 221, and the abutting section 221 is disengageably abutted against the wall 13 so that the two of said elastic arms 22 are easy to be swung. Furthermore, a chamfer 223 is connected between the curve section 222 and the seat 20. A thickness of the abutting section 221 is larger than that of the curve section 222 so that the seat 20 is smoothly swung within the accommodation room 12 and configured to urge the workpiece 2. Preferably, the two of said elastic arms 22 are respectively disposed on two opposite sides of the seat 20 for preferable positioning of the workpiece 2.

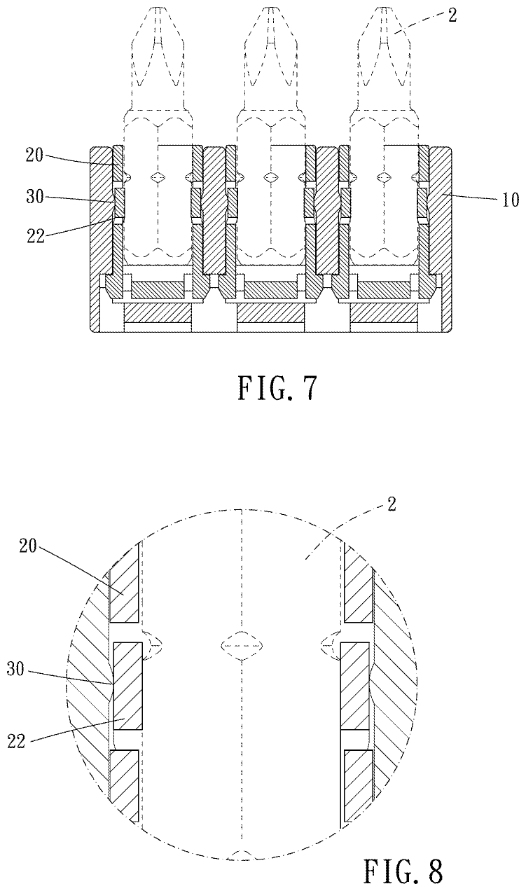

One of the at least one elastic arm 22 and the wall 13 includes a projection 30 abutted against the other of the at least one elastic arm 22 and the wall 13. Preferably, the projection 30 includes an arcuate face 31 so as to smoothly come into and abut against the wall 13, and each of the two of said elastic arms 22 is configured with its the projection 30 urged by the wall 13 and swings into to the slot 21. In other embodiments, the projection may include a ramp. In this embodiment, each of the two of said elastic arms 22 includes a projection 30 which is abutted against the wall 13. Please refer to FIGS. 7 and 8 for a second preferable embodiment, the wall 13 includes the projection 30 abutted against one of the two of said elastic arms 22. In other embodiments, an inner wall of the slot may be provided with the projection for abutting against the workpiece, and an outside of each of the two said elastic arms protrudes beyond an outside of the seat so as to be abutted against the wall.

Moreover, the seat 20 further includes two legs 40, and the wall 13 includes two mounting portions 50. One of respective one of the two legs 40 and respective one of the two mounting portions 50 includes a hole and the other includes a pin disengageably attached rotatably to one of the hole. In this embodiment, each of the two legs 40 includes one of the pin 41 which includes a ramp 42 configured for easy installation of the seat 20, and each of the two mounting portions 50 includes one of the hole 51. Each of the two legs 40 corresponds to and is swingable relative to one of the slot 21 for easy assembling/disassembling and stable connection. Specifically, the rotation axis 3 is an axis of one of the hole 51 of the two mounting portions 50 and one of the pin 30 of the two legs 40. Furthermore, one of the two legs 40 and one of the two of said elastic arms 22 are disposed on the same one of the two side walls 14 so that the seat 20 can be stably swung and configured to stably restrict the workpiece 2.

The seat 20 includes a bottom surface 23 which is V-shaped, and the bottom surface 23 includes a first inclined surface 231 and a second inclined surface 232. The wall 13 of the accommodation room 12 includes a bottom wall 15, and the first inclined surface 231 is abuttable against the bottom wall 15. A space 24 is defined between the second inclined surface 232 and the wall 13 so that the seat 20 can be smoothly swung relative to the accommodation room 12 and a swinging angle of the seat 20 is restricted to prevent the seat 20 from overswing. The slot 21 includes a supporting surface 211 radially protruding inward, and the supporting surface 211 is configured to be abutted against the workpiece 2 and hold the workpiece 2.

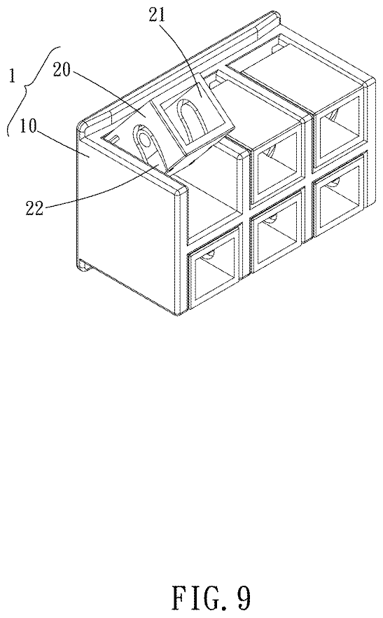

Furthermore, the base 10 may be configured to be upright (as shown in FIG. 1) or horizontal (as shown in FIG. 9) so that an opening of the slot 21 of the seat 20 can face toward different direction. The seat may be swung toward another direction relative to the base, and a structure of the base may be different according to various requirements.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool storage device, including:
a base, including a receiving portion, the receiving portion including an accommodation room and a wall defining the accommodation room;
a seat, swingably disposed within the accommodation room, the seat including a slot and at least one elastic arm, the slot being configured to detachably receive a workpiece, the at least one elastic arm disengageably abutted laterally against the wall and being configured to urge the workpiece within the slot.

2. The tool storage device of claim 1, wherein the wall extends circumferentially.

3. The tool storage device of claim 2, wherein the seat swings relative to the accommodation room about a rotation axis, the wall includes two side walls oppositely arranged, the rotation axis extends through the two side walls, and the at least one elastic arm is disengageably abutted against one of the two side walls.

4. The tool storage device of claim 2, wherein one of the at least one elastic arm and the wall includes a projection abutted against the other of the at least one elastic arm and the wall.

5. The tool storage device of claim 4, wherein the projection includes an arcuate face.

6. The tool storage device of claim 3, wherein the seat includes two of said elastic arms, and the two of said elastic arms are disengageably abutted against respective one of the two side walls.

7. The tool storage device of claim 1, wherein the slot is open toward a first direction, and the at least one elastic arm extends transvers to the first direction.

8. The tool storage device of claim 1, wherein each of the at least one elastic arm includes an abutting section and a curve section which is connected between the seat and the abutting section, and the abutting section is disengageably abutted against the wall.

9. The tool storage device of claim 8, wherein a chamfer is connected between the curve section and the seat.

10. The tool storage device of claim 1, wherein the seat further includes two legs, the wall includes two mounting portions, one of respective one of the two legs and respective one of the two mounting portions includes a hole and the other includes a pin disengageably attached rotatably to one of the hole.

11. The tool storage device of claim 10, wherein each of the two legs includes one of the pin which includes a ramp configured for easy installation of the seat, and each of the two mounting portions includes one of the hole.

12. The tool storage device of claim 3, wherein a number of the receiving portion is plural, and a number of the seat corresponds to the number of the receiving portion; the at least one elastic arm includes a projection abutted against the wall; the projection includes an arcuate face; the seat includes two of said elastic arms, the two of said elastic arms are respectively disengageably abutted against one of the side walls; the two of said elastic arms are respectively disposed on two opposite sides of the seat; the slot is open toward a first direction, and the two of said elastic arms extend transvers to the first direction; each of the two of said elastic arms includes an abutting section and a curve section which is connected between the seat and the abutting section, and the abutting section is disengageably abutted against the wall; a chamfer is connected between the curve section and the seat; the seat includes two legs, the wall includes two mounting portions, one of respective one of the two legs and respective one of the two mounting portions includes a hole and the other includes a pin disengageably attached rotatably to one of the hole; each of the two legs includes one of the pin which includes a ramp configured for easy installation of the seat, and each of the two mounting portions includes one of the hole; one of the two legs and one of the two of said elastic arms are disposed on the same one of the two side walls; the seat includes a bottom surface which is V-shaped, and the bottom surface includes a first inclined surface and a second inclined surface, the wall of the accommodation room includes a bottom wall, the first inclined surface is abuttable against the bottom wall, a space is defined between the second inclined surface and the wall; the slot includes a supporting surface radially protruding inward, the supporting surface is configured to be abutted against the workpiece.
